(19) United States
(12) Patent Application Publication
(10) Pub. No.: US 2025/0138708 A1
(43) Pub. Date: May 1, 2025

(54) CONVERSATION INTERACTION

(71) Applicants: Beijing Zitiao Network Technology Co., Ltd., Beijing (CN); Lemon Inc., Grand Cayman (KY)

(72) Inventors: Xin Zhong, Beijing (CN); Junyuan Qi, Beijing (CN); Qinxian Xia, Beijing (CN); Shanshan Du, Beijing (CN); Chen Fu, Los Angeles, CA (US)

(21) Appl. No.: 18/934,105

(22) Filed: Oct. 31, 2024

(30) Foreign Application Priority Data
Oct. 31, 2023 (CN) 202311436564.5

(51) Int. Cl. G06F 3/0484; H04L 51/02; H04L 51/216

(52) U.S. Cl. CPC G06F 3/0484; H04L 51/02; H04L 51/216

(57) ABSTRACT

The embodiments of the present disclosure provide methods and apparatuses for conversation interaction, a device, and a storage medium. In the method for conversation interaction, a conversation continuation entry for at least one topic in a first conversation is presented in a conversation window of a first conversation, and a conversation continuation entry for a first topic in at least one topic is presented independently of a conversation message of the corresponding topic. In response to detecting a trigger on the conversation continuation entry for the first topic, a first topic region corresponding to the first topic is presented, the first topic region including a conversation message related to the first topic in the first conversation.

### CROSS-REFERENCE

This application claims priority to Chinese Patent Application No. 202311436564.5 filed on Oct. 31, 2023, and entitled “CONVERSATION INTERACTION METHODS, APPARATUSES, DEVICE AND STORAGE MEDIUM”, which is incorporated herein by reference in its entirety.

### FIELD

Example embodiments of the present disclosure generally relate to the field of computers, and in particular, to methods and apparatuses for conversation interaction, a device, and a computer-readable storage medium.

### BACKGROUND

With rapid development of Internet technologies, the Internet has become an important platform for people to obtain content and share content, and users can access the Internet through terminal devices to enjoy various Internet services. The terminal device presents the corresponding content through a user interface of the application and implements interaction with the user and provides service to the user. Therefore, colorful interactive interfaces of an application are an important means in improving user experience. With the development of information technologies, various terminal devices may provide various services to people in terms of work and life. For example, an application providing a service may be deployed in the terminal device. The terminal device or application may provide a function of digital assistant to assist the user in using the terminal device or the application. How to improve the flexibility of interaction between a user and a digital assistant is a problem to be explored currently.

### SUMMARY

In a first aspect of the present disclosure, a method for conversation interaction is provided. The method includes: presenting, in a conversation window of a first conversation, a conversation continuation entry for at least one topic in the first conversation, the conversation continuation entry for a first topic of the at least one topic being presented independently of a conversation message of a corresponding topic; and in response to detecting a trigger on the conversation continuation entry for the first topic, presenting a first topic region corresponding to the first topic, the first topic region including a conversation message related to the first topic in the first conversation.

In a second aspect of the present disclosure, a method for conversation interaction is provided. The method includes: presenting a topic viewing entry in a conversation window of a first conversation; and in response to detecting a trigger on the topic viewing entry, presenting a topic list in the first conversation; and in response to detecting that a first topic in the topic list is selected, presenting content of the first topic.

In a third aspect of the present disclosure, an apparatus for conversation interaction is provided. The apparatus includes: a continuation entry presenting module configured to present, in a conversation window of a first conversation, a conversation continuation entry for at least one topic in the first conversation, the conversation continuation entry for a first topic of the at least one topic being presented independently of a conversation message of a corresponding topic; and a topic region presenting module configured to present, in response to detecting a trigger on the conversation continuation entry for the first topic, a first topic region corresponding to the first topic, the first topic region comprising a conversation message related to the first topic in the first conversation.

In a fourth aspect of the present disclosure, an apparatus for conversation interaction is provided. The apparatus includes a viewing entry presenting module configured to present a topic viewing entry in a conversation window of a first conversation; a topic list presenting module configured to present a topic list in the first conversation in response to detecting a trigger on the topic viewing entry; and a topic content presenting module configured to present content of the first topic in response to detecting that a first topic in the topic list is selected.

In a fifth aspect of the present disclosure, an electronic device is provided. The apparatus includes at least one processing unit; and at least one memory coupled to the at least one processing unit and storing instructions for execution by the at least one processing unit. The instructions, when executed by the at least one processing unit, cause the device to implement the method of the first aspect and/or the method of the second aspect.

In a sixth aspect of the present disclosure, a computer-readable storage medium is provided. The computer-readable storage medium stores a computer program, and the computer program is executable by the processor to implement the method of the first aspect and/or the method of the second aspect.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIGS. 2A-2F illustrate schematic diagrams of an example client interface according to some embodiments of the present disclosure;

FIG. 3 illustrates a flowchart of a process for conversation interaction according to some embodiments of the present disclosure;

FIG. 4 illustrates a flowchart of a process for conversation interaction according to some other embodiments of the present disclosure;

FIG. 5 illustrates a block diagram of an apparatus for conversation interaction according to some embodiments of the present disclosure;

FIG. 6 illustrates a block diagram of an apparatus for conversation interaction according to some other embodiments of the present disclosure; and

FIG. 7 illustrates a block diagram of an electronic device in which one or more embodiments of the present disclosure may be implemented.

### DETAILED DESCRIPTION

Embodiments of the present disclosure will be described in more detail below with reference to the accompanying drawings. Although some embodiments of the present disclosure are shown in the drawings, it would be understood that the present disclosure can be implemented in various forms and should not be construed as limited to the embodiments set forth herein. On the contrary, these embodiments are provided for a more thorough and complete understanding of the present disclosure. It would be understood that the drawings and embodiments of the present disclosure are provided for illustrative purposes only and are not intended to limit the scope of protection of the present disclosure.

In the description of the embodiments of the present disclosure, the term “including” and the like should be understood as non-exclusive inclusion, that is, “including but not limited to”. The term “based on” should be understood as “based at least in part on.” The term “one embodiment” or “the embodiment” should be understood as “at least one embodiment”. The term “some embodiments” should be understood as “at least some embodiments”. Other explicit and implicit definitions may also be included below.

Herein, unless explicitly stated, performing one step “in response to A” does not imply that this step is performed immediately after “A”, but one or more intermediate steps may be included.

It will be appreciated that the data involved in the technical solution (including but not limited to the data itself, and obtaining, using, storing, or deleting the data) should comply with the requirements of the corresponding legal regulations and related provisions.

It will be appreciated that, before using the technical solutions disclosed in the various embodiments of the present disclosure, a relevant user would be informed of the type, application scope, and application scenario of the information involved in this disclosure in an appropriate manner and the relevant user's authorization would be obtained, in accordance with relevant laws and regulations, wherein the related user may include any type of right body, such as an individual, an enterprise, or a group.

For example, in response to receiving an active request from a relevant user, prompt information is sent to the relevant user to explicitly prompt the relevant user that an operation requested by the relevant user will require obtaining and use of information of the relevant user. Thus, the user can autonomously select, according to the prompt information, whether to provide information to software or hardware such as an electronic device, an application program, a server, or a storage medium that executes the operations of the technical solutions of the present disclosure.

As an optional but non-limiting implementation, in response to receiving an active request from the relevant user, prompt information is sent to the relevant user, for example, in the form of a pop-up window, and the pop-up window may present the prompt information in the form of text. In addition, the pop-up window may also carry a selection control for the user to select whether he/she “agrees” or “disagrees” to provide information to the electronic device.

It can be understood that the above notification and user authorization process are only illustrative, which do not limit the implementation of this disclosure. Other methods that meet relevant laws and regulations can also be applied to the implementation of this disclosure.

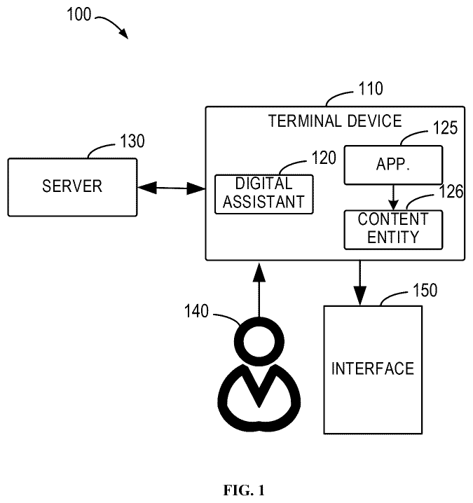

FIG. 1 illustrates a schematic diagram of an example environment 100 in which embodiments of the present disclosure can be implemented. In this example environment 100, a digital assistant 120 and an application 125 are installed in the terminal device 110. The user 140 may interact with the digital assistant 120 and the application 125 via the terminal device 110 and/or an attachment device of the terminal device 110.

In some embodiments, the digital assistant 120 and the application 125 may be downloaded and installed on the terminal device 110. In some embodiments, the digital assistant 120 and the application 125 may also be accessed in other manners, such as web page access. In the environment 100 of FIG. 1, in response to the application 125 being started, the terminal device 110 may present an interface 150 of the digital assistant 120 and the application 125.

The application 125 include, but are not limited to, one or more of the following: chat applications (also known as instant messaging applications), document applications, audio and video conferencing applications, mail applications, task applications, calendar applications, Objectives and Key Results (OKR) applications, and so forth. Although a single application is shown in FIG. 1, in practice, multiple applications may be installed on the terminal device 110. In some embodiments, the application 125 may include a multifunction collaboration platform, such as an office collaboration platform (also referred to as an office suite), which can provide integration of multiple types of applications or components, so that people can conveniently perform activities such as work and communication. In a multifunctional collaboration platform, people can start different applications or components as needed to complete corresponding information processing, sharing, communication and the like.

The application 125 may provide a content entity 126. The content entity 126 may be a content instance created by a user 140 or other users on the application 125. For example, depending on the type of the application 125, the content entity 126 may be a document (e.g., a Word document, a PDF document, a presentation, an Excel document, etc.), a mail, a message (e.g., a conversation message on an instant messaging application), a calendar, a schedule, a task, an audio, a video, an image, or the like.

In some embodiments, the digital assistant 120 may be provided by a separate application, or may be integrated in the application 125 capable of providing the content entity. The application for providing a client interface of the digital assistant may correspond to a single-function application or a multifunction collaboration platform, such as an office suite or other collaboration platform capable of integrating multiple components. In some embodiments, the digital assistant 120 supports using plug-ins. Each plug-in can provide one or more functions of the application. Such plug-ins include, but are not limited to, one or more of a search plug-in, a contact plug-in, a message plug-in, a document plug-in, a table plug-in, a mail plug-in, a calendar plug-in, a schedule plug-in, a task plug-in, and the like. In some embodiments, the plug-in itself may also complete a corresponding task by calling a model, or the plug-in may also call an open interface provided by a service component (document, calendar, conference, etc.) to complete the corresponding task (for example, modify the document, create a schedule, summarize a conference, etc.).

The digital assistant 120 is an intelligent assistant of a user, and has capabilities of performing an intelligent dialogue and information processing. In an embodiment of the present disclosure, the digital assistant 120 is configured to interact with the user 140 to assist the user 140 in using the terminal device or the application. An interaction window with the digital assistant 120 may be presented in a client interface. In the interaction window, the user 140 can have a dialog with the digital assistant 120 by inputting a natural language, to instruct the digital assistant to assist in completing various tasks, including performing operations on the content entity 126.

In some embodiments, the digital assistant 120 may be included in a contact list of a current user 140 in the office suite as a contact of the user 140, or may be included in the feed of a chat component. In some embodiments, the user 140 has correspondence with the digital assistant 120. For example, a first digital assistant corresponds to a first user, a second digital assistant corresponds to a second user, and so on. In some embodiments, the first digital assistant may uniquely correspond to the first user, the second digital assistant may uniquely correspond to the second user, and so on. That is, the first digital assistant of the first user may be specific to or dedicated to the first user. For example, in a process during which the first digital assistant provides assistance or service for the first user, the first digital assistant may utilize its historical interaction information with the first user, data authorized by the first user that can be accessed, current interaction context with the first user, and the like. If the first user is an individual or a person, the first digital assistant may be considered as a personal digital assistant. It may be understood that the first digital assistant in embodiments of the disclosure accesses data being authorized based on the authorization of the first user. It should be understood that the “unique correspondence” or the like in this disclosure is not intended to limit that the first digital assistant will be updated accordingly based on the interaction process between the first user and the first digital assistant. Of course, the digital assistant 120 is not necessarily specific to the current user 140, but may be a universal digital assistant, depending on the actual application needs.

In some embodiments, a plurality of interaction modes between the user 140 and the digital assistant 120 may be provided, and switching may be flexibly performed between the plurality of interaction modes. In a case that a certain interaction mode is triggered, a corresponding interaction region is presented to facilitate interaction of the user 140 with the digital assistant 120. The interaction manners of the user 140 with the digital assistant 120 are different in different interaction modes, which can flexibly be adapted to interaction requirements in different application scenarios.

In some embodiments, an information processing service specific to the user 140 can be provided based on historical interaction information of the user 140 with the digital assistant 120 and/or a data range specific to the user 140. In some embodiments, the historical interaction information of the user 140 interacting with the digital assistant 120 respectively in the plurality of interaction modes respectively may be stored in association with the user 140. As such, in one of the plurality of interaction modes (anyone or a designated one interaction mode), the digital assistant 120 may provide services to the user 140 based on the historical interaction information stored in association with the user 140.

The digital assistant 120 may be called or waken up in an appropriate manner (e.g., via a shortcut key, button, or voice) to present an interaction window with the user 140. By selecting the digital assistant 120, an interaction window with the digital assistant 120 may be opened. The interaction window may include an interface element for information exchange, such as an input box, a message list, a message bubble, and the like. In some other embodiments, the digital assistant 120 may be waken up through an entry control or a menu provided in the page, or may be activated by inputting a predetermined instruction. In some embodiments described below, for ease of discussion, the description is provided mainly by taking the interaction window between the user and the digital assistant as an example of the conversation window.

In some embodiments, the terminal device 110 communicates with the server 130 to obtain provision of services to the digital assistant 120 and the application 125. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a television receiver, a radio broadcast receiver, an electronic book device, a gaming device, or any combination of the foregoing, including accessories and peripherals of these devices, or any combination thereof. In some embodiments, the terminal device 110 can also support any type of interface for a user (such as a “wearable” circuit, etc.). The server 130 may be various types of computing systems/servers providing computing capabilities, including, but not limited to, mainframes, edge computing nodes, computing devices in a cloud environment, and so forth.

It should be understood that the structures and functions of the various elements in the environment 100 are described for exemplary purposes only and do not imply any limitation to the scope of the present disclosure.

As briefly mentioned above, the digital assistant may assist a user in using a terminal device or an application. Some applications can provide integration of different plugins. In addition to having a free dialogue with the digital assistant, the user can make the digital assistant complete some more complex operations related to a business of the application by using different plug-ins through a natural language instruction, such as document creation, schedule invitation, task creation, and the like. However, since most users are not capable of exploring the usage scenarios of the digital assistant through interaction with the digital assistant, targeted guidance needs to be provided for the user. In addition, traditionally, due to the limitation of the number of tokens in the large language model, a new topic needs to be newly started if the dialogue is too long or the user needs to enable a new scenario. The conversation context between different topics is disconnected, that is, although the conversations between different topics in a private chat window are in a list, but the chatting cannot be performed continuously. This may make the digital assistant incapable of meeting the user's desire in picking up the chat in the previous historical topics.

According to some embodiments of the present disclosure, an improved solution for conversation interaction is presented. In an embodiment of the present disclosure, in the conversation window of the first conversation, a conversation continuation entry for at least one topic in the first conversation is presented, and the conversation continuation entry for the first topic of the at least one topic is presented independently of a conversation message of the corresponding topic. In response to detecting a trigger on the conversation continuation entry for the first topic, a first topic region corresponding to the first topic is presented, where the first topic region includes a conversation message related to the first topic in the first conversation. In this way, by providing the conversation continuation entry for the historical topic, it allows the user to select a historical topic in the interaction so that the user can perform interactions with the digital assistant in the selected historical topic.

According to some embodiments of the present disclosure, an improved solution for conversation interaction is presented. In an embodiment of the present disclosure, the topic viewing entry is presented in a conversation window of the first conversation. In response to detecting the trigger on the topic viewing entry, the topic list in the first conversation is presented. In response to detecting that a first topic in the topic list is selected, the content of the first topic is presented. In this way, the topics can be flexibly selected based on user requirements, achieving diverse interaction operations with the digital assistant.

Some example embodiments of the present disclosure will be described in detail below with reference to examples of the accompanying drawings.

As described above, in an embodiment of the present disclosure, the digital assistant is configured to interact with a user. An interactive window between the user and the digital assistant may be presented in the client interface. The interaction window between the user and the digital assistant may include a conversation window, and the interaction between the user and the digital assistant in the conversation window may be presented in a form of a conversation message. Alternatively, or in addition, the interaction window between the user and the digital assistant may further include other types of windows, such as a window in a floating window mode, where the user may trigger the digital assistant to perform a corresponding operation by inputting an instruction, selecting a shortcut instruction, or the like. The digital assistant serves as an intelligent assistant, and has capabilities of performing an intelligent dialogue and information processing. In the interaction window, the user inputs an interaction message, and the digital assistant provides a reply message in response to the user input. A client interface for providing a digital assistant may correspond to a single-function application or a multifunction collaboration platform, such as an office suite or other collaboration platform capable of integrating multiple components.

In some embodiments, the terminal device 110 may present a conversation window between a user and another user or between a user and a plurality of users. The conversation window between a user and another user herein may be, for example, a private chat window between user A and user B; and the conversation window between a user and a plurality of other users may be, for example, a group chat window between the user A and another group of users. A user may interact with at least one other user by transmitting and/or receiving messages in the conversation window. For example, the terminal device 110 may determine, in response to detecting text input by a user in the input box, message content to be sent by the user. For example, the terminal device 110 may further collect user audio in response to detecting a trigger of the user on the audio space. The terminal device 110 may determine the audio or text content corresponding to the audio as the message content to be sent by the user. It should be noted that the operations performed by the terminal device 110 described above and the operations performed by the terminal device 110 described subsequently may be specifically performed by a related application installed on the terminal device 110.

In a conversation window, a user may input a message through an input box or by other appropriate means (e.g., voice), and the digital assistant may provide a reply message based on the input message and in conjunction with relevant knowledge. The messages in the conversation window are typically conversation messages. Such a conversation message may be considered as a part of a topic.

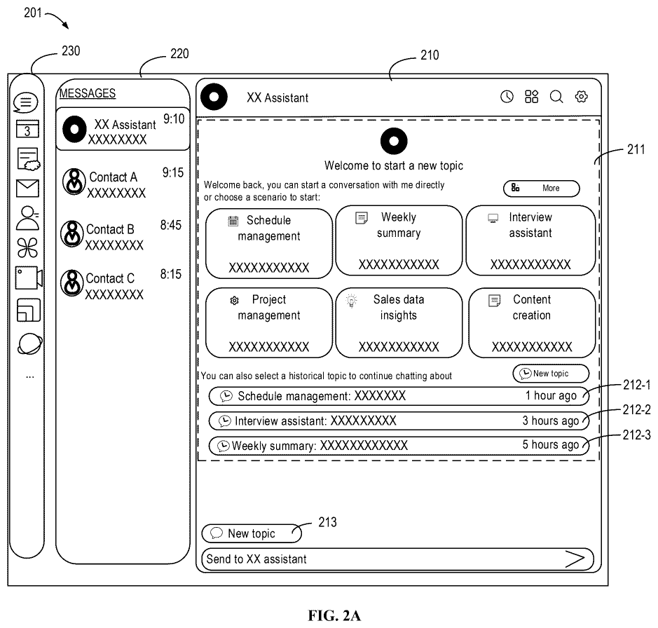

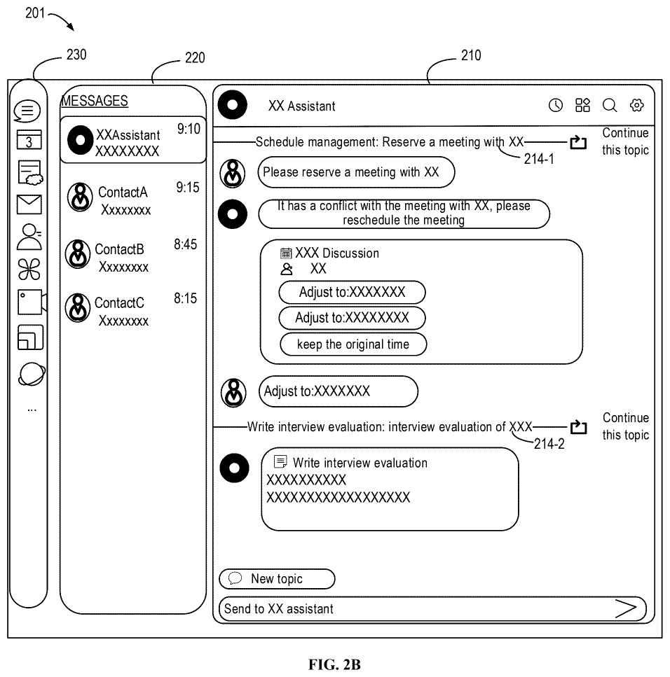

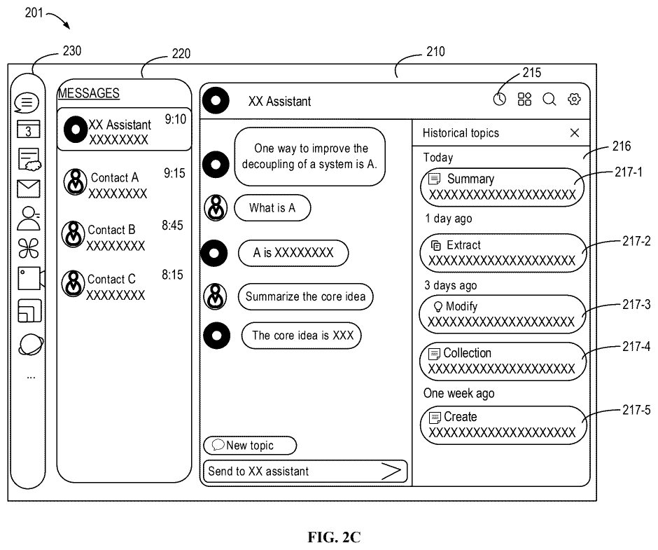

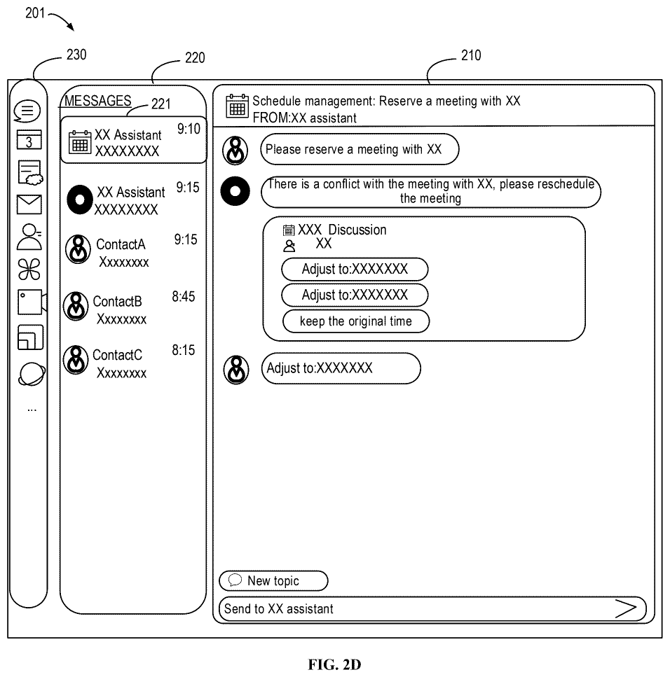

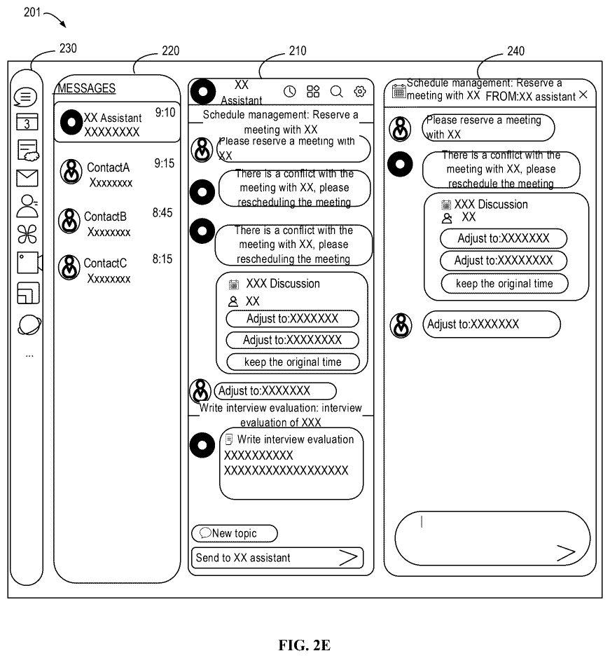

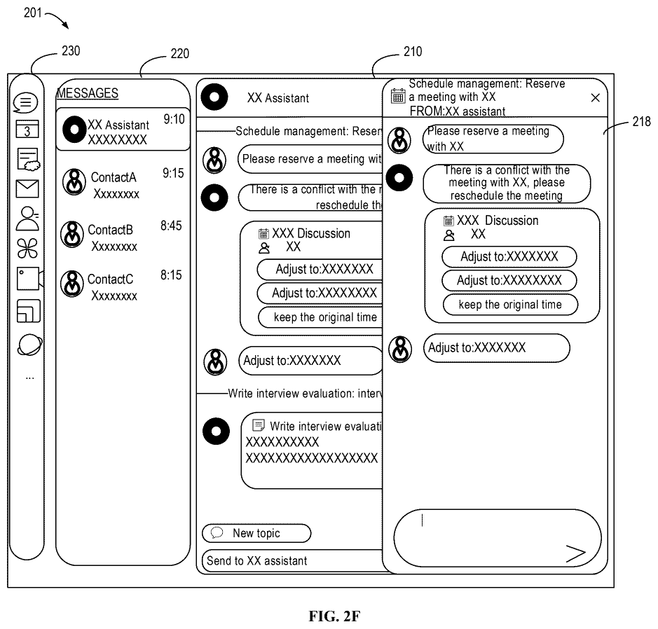

FIGS. 2A-2F illustrate schematic diagrams of an example client interface 201 according to some embodiments of the present disclosure. The client interface 201 may be implemented at the terminal device 110. Examples of FIGS. 2A-2F are described below with reference to FIG. 1.

In a conversation window between a user and at least one other user, the terminal device 110 (for example, an instant messaging application installed on the terminal device 110, or a suite application installed on the terminal device 110 integrated with an instant messaging application) may present, in response to detecting a predetermined input in an input box of the conversation window, a triggering control for the digital assistant (for example, the first digital assistant). As shown in FIG. 2A, a startup entry of the instant messaging application is presented in region 230 of interface 201, and the feed of the instant messaging application is presented in region 220 of interface 201. In response to the user selecting any contact or any group from the feed of the instant messaging application, the terminal device 110 may present a corresponding conversation window in the region 210 of the interface 201. For example, in response to a user waking up a digital assistant through a predetermined operation (for example, selecting a digital assistant from a contact list), the terminal device 110 may present a conversation window (also referred to as a main conversation window) for interaction between the user and the digital assistant in the region 210 of the interface 201. For another example, in response to the user selecting another user from the contact list, the terminal device 110 may present a private chat window between the user and the selected user in the region 210 of the interface 201 (if the user is a first user and the selected other user is a second user, the terminal device 110 may present a private chat window between the first user and the second user in the region 201). For another example, if in response to the user selecting a group of users from the contact list, the terminal device 110 may present a group chat window between the user and a group of users in the region 210 of the interface 201. That is, the conversation window presented by the terminal device 110 in the interface 201 may be a conversation window between the user and the digital assistant, a group chat window between the user and other users, or a group chat window between the user and a group of users, and the like. For ease of description, the following describes a conversation window between the user and the digital assistant as an example of the conversation window presented in the region 201.

In an embodiment of the present disclosure, the terminal device 110 presents, in a conversation window of the first conversation, a conversation continuation entry for at least one topic in the first conversation. In some embodiments, different topics correspond to different conversation continuation entries. When the conversation window includes a plurality of topics, conversation continuation entries corresponding respectively to the plurality of topics are presented. Herein, a “topic” corresponds to a particular context of an interaction. During the interaction process of each topic, the interaction information between the user and the digital assistant may be considered as context information, to assist the digital assistant in determining a subsequent conversation message. In some embodiments, a topic sometimes is also referred to as or presented as a theme.

The conversation continuation entry for any of the at least one topic herein is presented independently of the conversation message of the corresponding topic. In some embodiments, the terminal device 110 may present, in response to a new topic starting operation, a new topic guidance message in the conversation window of the first conversation, where the new topic guidance message includes a conversation continuation entry for at least one recommended historical topic in the first conversation (that is, a conversation between the user and the digital assistant). Regarding the new topic starting operation, in some embodiments, in response to the digital assistant being waken up, the terminal device 110 may receive a new topic starting operation by default, start a new topic in the conversation window, and present the new topic guidance message in the conversation window. In some embodiments, if there is historical interaction information or a historical topic between the user and the digital assistant, in response to the digital assistant being evoked, the terminal device 110 may present the historical interaction information or the historical topic in the conversation window. Alternatively, or in addition, in some embodiments, in response to the digital assistant being waken up, the terminal device 110 may not present any message in the primary conversation window.

In some embodiments, the conversation window may include an input box, and the terminal device 110 may, for example, receive a user input through the input box. The terminal device 110 may determine that it has received a new topic starting operation, in response to detecting that the user input is a user input indicating to start a new topic. In some embodiments, the conversation window may further include an operation control for starting a new topic. For example, the terminal device 110 may determine that it has received a new topic starting operation, for example, in response to detecting a trigger on the operation control (for example, a click operation, a long-press operation, a double-click operation, or the like). The terminal device 110 may then start a new topic in the conversation window, and present a new topic guidance message in the conversation window. As shown in FIG. 2A, in some embodiments, in response to the digital assistant being waken up, the terminal device 110 may present a new topic guidance message 211 in the interface 201 by default. In some embodiments, the interface 201 further includes an operation control 213 for starting a new topic. The terminal device 110 may present the new topic guidance message 211 in the interface 201, in response to detecting a trigger on the operation control 213. In some embodiments, the terminal device 110 may also present the new topic guidance message by presenting a message card.

In some embodiments, the terminal device 110 may determine all historical topics in the first conversation as the at least one recommended historical topic included in the new topic guidance message, that is, the terminal device 110 may present, in the new topic guidance message, conversation continuation entries of all historical topics. In some embodiments, to keep the conversation window clan, the at least one recommended historical topic included in the new topic guidance message may further include only a predetermined number of recent historical topics in the first conversation. This predetermined number may be predetermined, for example, by a user and/or by an associated backstage staff. For example, if the predetermined number is three and there are five historical topics, the terminal device 110 may determine, based on their respective update time, three recent historical topics closest to the current time. The terminal device 110 may determine the three recent historical topics as the at least one recommended historical topic included in the new topic guidance message. It may be understood that, if the number of historical topics is less than the predetermined number, the terminal device 110 may determine all historical topics as the at least one recommended historical topic included in the new topic guidance message. As shown in FIG. 2A, if the predetermined number is three, the new topic guidance message 211 may include only the conversation continuation entries (i.e., the conversation continuation entries 212-1, 212-2, and 212-3) of three recent history topics.

In some embodiments, the terminal device 110 may present, in the conversation window, a topic division line between two adjacent topics (that is, conversation messages in two adjacent topics in the conversation window are separated by using the topic division line), and present a topic identifier of the corresponding topic at the topic division line. For example, the terminal device 110 may present a topic division line between the current topic and a previous topic and before the current topic, and present a topic identifier of the current topic at the topic division line. The terminal device 110 may, for example, present a conversation continuation entry for the corresponding topic in association with the topic division line (which may also be referred to as that the conversation continuation entry is presented at an associated location of the topic division line for the corresponding topic in the conversation window). As shown in FIG. 2B, the terminal device 110 may present, in a region 210 of the interface 201, a topic division line 214 (e.g., including the topic division lines 214-1, 214-2, etc.) for isolating each topic from a previous topic. The terminal device 110 may present a conversation continuation entry in association with the topic division line 214. For example, the terminal device 110 may present a control “Continue with the topic” at a topic division line 214 corresponding to each topic, where the control “Continue with the topic” is a conversation continuation entry corresponding to the topic. For example, the control “Continue with the topic” presented at the topic division line 214-1 is a conversation continuation entry for the topic “Schedule Management: Reserving a meeting with XX”, and the control “Continue with the topic” presented in the topic division line 214-2 is a conversation continuation entry for the topic “Write an interview evaluation: interview evaluation for XXXX”. In this way, the user may search for a region corresponding to the topic that the user expects to continue by scrolling through the messages in the conversation window, and continue the interaction in the topic by clicking on the conversation continuation entry at the topic division line corresponding to the topic.

In some embodiments, the terminal device 110 may also present a topic viewing entry in the conversation window. This topic viewing entry may be presented anywhere in the conversation window, such as it may be presented in a functional region of the conversation window. The terminal device 110 may present, in response to detecting a trigger on the topic viewing entry, a topic list in the first conversation. At least some of the topics in the topic list may have its conversation continuation entry. As shown in FIG. 2C, the terminal device 110 may present a plurality of operation controls in a functional region of the conversation window. A topic viewing entry 215 may be included in the plurality of operational controls. The terminal device 110 may present the topic list 216 in response to detecting a trigger on the topic viewing entry 215. The topic list 216 may include conversation continuation entries 217 (e.g., conversation continuation entries 217-1, 217-2, 217-3, 217-4, 217-5, etc.) that each correspond to at least one historical topic in the first conversation.

It would be understood that, in a case where there are a plurality of historical topics, the terminal device 110 may only present, in the topic list 216, the conversation continuation entries 217 corresponding to some of all the historical topics. Further, the terminal device 110 may present historical topic entries corresponding to more historical topics 217, in response to receiving an upward sliding operation and/or a downward sliding operation in the topic list 216. In addition to presenting the topic list in the conversation window shown in FIG. 2C, in some embodiments, the terminal device 110 may also present a region for presenting the topic list 216 in the interface 201. The region may be presented in interface 201 together with the region 210, the region 220, and the region 230. In some embodiments, the terminal device 110 may further switch from an interface 201 to an interface for presenting the topic list 216, in response to detecting the trigger on the topic viewing entry. The present disclosure does not limit the specific display mode for the topic list.

In an embodiment of the present disclosure, the terminal device 110 presents a first topic region corresponding to the first topic, in response to detecting a trigger on the conversation continuation entry for the first topic. The first topic region includes a conversation message related to the first topic in the first conversation. For example, the terminal device 110 may determine that the first topic being selected is detected, in response to detecting a trigger on a conversation continuation entry for the first topic. The terminal device 110 may further present a first topic region corresponding to the first topic, and present content of the first topic in the first topic region.

Regarding the presentation manner for the first topic region, in some embodiments, the terminal device 110 may present a first topic region independently of the conversation window of the first conversation. In this case, the terminal device 110 may, for example, present a new conversation window corresponding to the first topic, where the conversation window is the first topic region. As shown in FIG. 2D, a case in which the selected first topic is topic “Schedule management: reserve a meeting with XX” is used as an example, and the terminal device 110 may present, in the region 220, the feed 221 corresponding to the first topic and present a conversation window for presenting content of the first topic in the region 201.

In some embodiments, the terminal device 110 may also present the first topic region together with the conversation window in different regions of a client interface. As shown in FIG. 2E, an example in which the selected first topic is topic “Schedule management: reserve a meeting with XX” is used as an example, the terminal device 110 may present a region 240 in the interface 201, and the region 240 is a first topic region for presenting the first topic.

In some embodiments, the terminal device 110 may further show the first topic region corresponding to the first topic directly in a predetermined region of the current conversation window. As shown in FIG. 2F, an example in which the selected first topic is topic “Schedule management: reserve a meeting with XX” is used as an example, and the terminal device 110 may present a region 218 in the conversation window. The region 218 is a first topic region for presenting a first topic.

As shown in FIG. 2D to FIG. 2F, in some embodiments, the first topic region includes an input region (for example, an input box), and the terminal device 110 may receive a subsequent message input by the user about the first topic based on the input region. For example, the terminal device 110 may receive a subsequent message input by the user about the first topic based on the input box.

In some embodiments, the terminal device 110 may record, in a region corresponding to the first topic in the conversation window of the first conversation, the conversation message received in the first topic region. As shown in FIG. 2E, the terminal device 110 may record the conversation message received in the region 240 in a region corresponding to the topic “Schedule management: reserve a meeting with XX” in the conversation window as shown in the region 210. That is, the terminal device 110 may record the message received in the region 240 in a region between the topic division line with a topic identifier “Schedule management: reserve a meeting with XX” and the topic division line with a topic identifier “Write interview evaluation: interview evaluation of XXXX” in the conversation window.

In summary, according to various embodiments of the present disclosure, during the interaction process between the user and the digital assistant, a conversation continuation entry for a historical topic may be provided, and the user may be supported to select the historical topic from the interaction, so that the user may perform the interaction with the digital assistant in the selected historical topic. In this way, the topic can be flexibly selected based on user requirements, thereby realizing a diverse interaction operation with the digital assistant.

It should be understood that some embodiments of the present disclosure are described above with reference to specific examples in the accompanying drawings, but these specific examples are not intended to limit the scope of the embodiments of the present disclosure. The described embodiments may also be implemented in various other deformation.

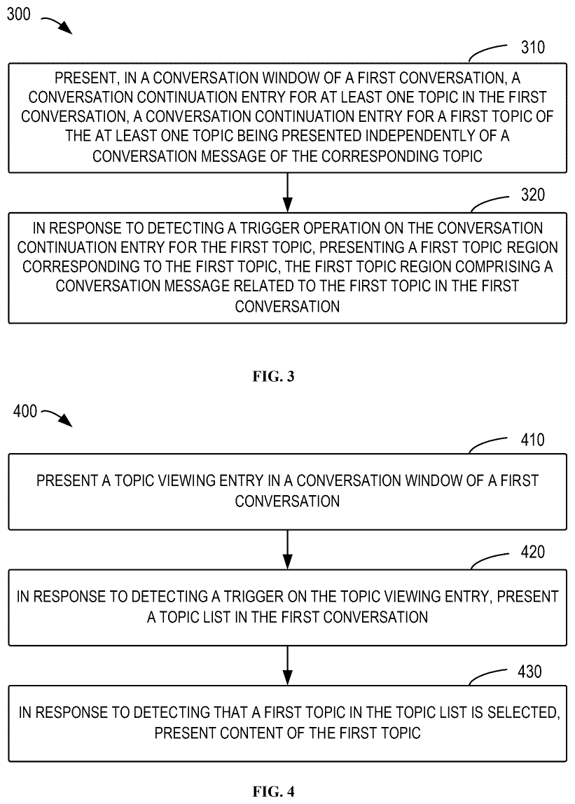

FIG. 3 illustrates a flowchart of a process 300 for conversation interaction according to some embodiments of the present disclosure. The process 300 may be implemented at the terminal device 110. The process 300 is described below with reference to FIG. 1.

At block 310, the terminal device 110 presents, in a conversation window of a first conversation, a conversation continuation entry for at least one topic in the first conversation, the conversation continuation entry for a first topic of the at least one topic being presented independently of a conversation message of the corresponding topic.

In block 320, the terminal device 110 presents, in response to detecting a trigger on the conversation continuation entry for the first topic, a first topic region corresponding to the first topic, the first topic region comprising a conversation message related to the first topic in the first conversation.

In some embodiments, the first topic region includes an input region based on which a subsequent message input by a user for the first topic is received.

In some embodiments, the conversation window includes one of: a conversation window between the first user and a digital assistant, a private chat window between the first user and a second user, or a group chat window between the first user and a group of users.

In some embodiments, presenting the conversation continuation entry for the at least one topic in the first conversation includes presenting a new topic guidance message in the conversation window of the first conversation, the new topic guidance message comprising a conversation continuation entry for at least one recommended historical topic in the first conversation.

In some embodiments, the new topic guidance message is presented in the conversation window of the first conversation in response to a new topic starting operation.

In some embodiments, the at least one recommended historical topic comprises a predetermined number of recent historical topics in the first conversation.

In some embodiments, the conversation continuation entry for the first topic of the at least one topic is presented at an associated location of a topic division line for a corresponding topic in the conversation window, wherein conversation messages in two adjacent topics in the conversation window are isolated using the topic division line.

In some embodiments, presenting the conversation continuation entry for the at least one topic in the first conversation includes: presenting a topic viewing entry in the conversation window of the first conversation; and in response to detecting a trigger on the topic viewing entry, presenting a topic list in the first conversation, at least part of topics in the topic list having a conversation continuation entry.

In some embodiments, a conversation message received in the first topic region is recorded in a region corresponding to the first topic in the conversation window of the first conversation.

In some embodiments, the first topic region is presented together with the conversation window in different regions of a client interface, or a location of the first topic region is independent of the conversation window, or the first topic region is shown in the predetermined region of the conversation window.

FIG. 4 illustrates a flowchart of a process 400 for conversation interaction according to some embodiments of the present disclosure. The process 400 may be implemented at the terminal device 110. The process 400 is described below with reference to FIG. 1.

At block 410, the terminal device 110 presents a topic viewing entry in a conversation window of the first conversation.

At block 420, the terminal device 110 presents a topic list in the first conversation in response to detecting a trigger on the topic viewing entry.

At block 430, the terminal device 110 presents content of the first topic in response to detecting that a first topic in the topic list is selected.

In some embodiments, presenting the content of the first topic includes: presenting a first topic region corresponding to the first topic, the first topic region comprising content of the first topic.

In some embodiments, the first topic region includes an input region based on which a subsequent message input by a user for the first topic is received.

In some embodiments, the first topic region is presented together with the conversation window in different regions of a client interface, or a location of the first topic region is independent of the conversation window, or the first topic region is shown in a predetermined region of the conversation window.

In some embodiments, a conversation message received in the first topic region is recorded in a region corresponding to the first topic in the conversation window of the first conversation.

In some embodiments, each topic in the topic list has a conversation continuation entry, and the process 400 further includes detecting that the first topic is selected in response to a trigger on a conversation continuation entry for the first topic.

In some embodiments, presenting the topic list includes presenting the topic list together with the first conversation window in different regions of a client interface.

In some embodiments, the topic viewing entry is presented in a functional region of the conversation window.

It should be understood that the process 300 and the process 400 described above may be implemented together or separately in a terminal device 110 of a certain user.

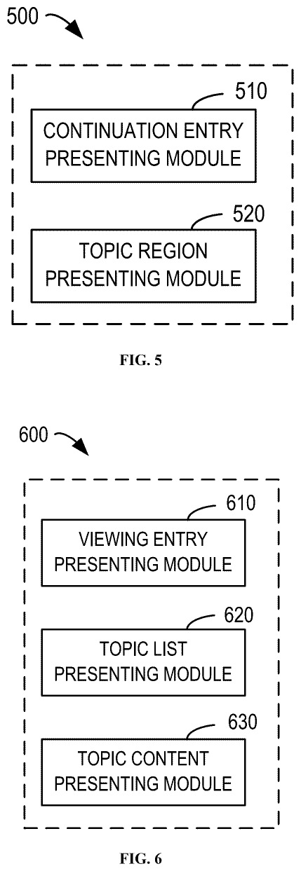

FIG. 5 illustrates a block diagram of an apparatus 500 for conversation interaction according to some embodiments of the present disclosure. For example, the apparatus 500 may be implemented in or included in the terminal device 110. Various modules/components in the apparatus 500 may be implemented by hardware, software, firmware, or any combination thereof.

As shown, the apparatus 500 includes a continuation entry presenting module 510 configured to present, in a conversation window of a first conversation, a conversation continuation entry for at least one topic in the first conversation, the conversation continuation entry for a first topic of the at least one topic being presented independently of a conversation message of a corresponding topic. The apparatus 500 further includes a topic region presenting module 520 configured to present, in response to detecting a trigger on the conversation continuation entry for the first topic, a first topic region corresponding to the first topic, the first topic region comprising a conversation message related to the first topic in the first conversation.

In some embodiments, the first topic region includes an input region based on which a subsequent message input by a user for the first topic is received.

In some embodiments, the conversation window includes one of the following: a conversation window between the first user and a digital assistant, a private chat window between the first user and a second user, or a group chat window between the first user and a group of users.

In some embodiments, the continuation entry presenting module 510 is further configured to present a new topic guidance message in the conversation window of the first conversation, the new topic guidance message comprising a conversation continuation entry for at least one recommended historical topic in the first conversation.

In some embodiments, the new topic guidance message is presented in the conversation window of the first conversation in response to a new topic starting operation.

In some embodiments, the at least one recommended historical topic includes a predetermined number of recent historical topics in the first conversation.

In some embodiments, the conversation continuation entry for the first topic of the at least one topic is presented at an associated location of a topic division line for a corresponding topic in the conversation window, wherein conversation messages in two adjacent topics in the conversation window are separated with the topic division line.

In some embodiments, the continuation entry presentation module 510 is further configured to: present a topic viewing entry in the conversation window of the first conversation; and in response to detecting a trigger on the topic viewing entry, present a topic list in the first conversation, at least part of topics in the topic list having a conversation continuation entry.

In some embodiments, a conversation message received in the first topic region is recorded in a region corresponding to the first topic in the conversation window of the first conversation.

In some embodiments, the first topic region is presented together with the conversation window in different regions of the client interface, or a location of the first topic region is independent of the conversation window, or the first topic region is shown in a predetermined region of the conversation window.

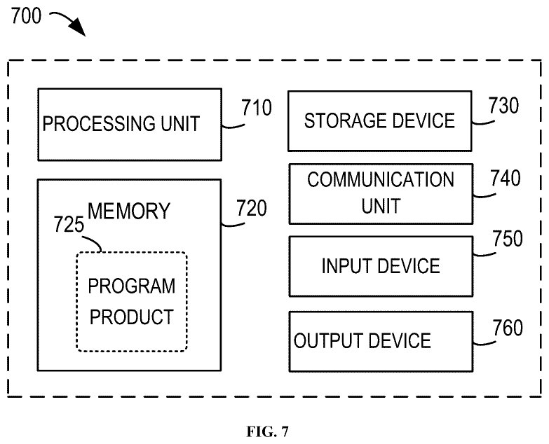

FIG. 6 shows a block diagram of an apparatus 600 for conversation interaction according to some embodiments of the present disclosure. For example, the apparatus 600 may be implemented in or included in the terminal device 110. The various modules/components in the apparatus 600 may be implemented by hardware, software, firmware, or any combination thereof.

As shown, the apparatus 600 includes a viewing entry presenting module 610 configured to present a topic viewing entry in a conversation window of a first conversation. The apparatus 600 further includes a topic list presenting module 620 configured to present a topic list in the first conversation in response to detecting a trigger on the topic viewing entry. The apparatus 600 further includes a topic content presenting module 630 configured to present content of the first topic in response to detecting that a first topic in the topic list is selected.

In some embodiments, the topic content presenting module 630 is further configured to: present a first topic region corresponding to the first topic, the first topic region comprising content of the first topic.

In some embodiments, the first topic region includes an input region based on which a subsequent message input by a user for the first topic is received.

In some embodiments, the first topic region is presented together with the conversation window in different regions of a client interface, or a location of the first topic region is independent of the conversation window, or the first topic region is shown in a predetermined region of the conversation window.

In some embodiments, a conversation message received in the first topic region is recorded in a region corresponding to the first topic in the conversation window of the first conversation.

In some embodiments, each topic in the topic list has a conversation continuation entry, and the apparatus 600 further includes a selection detecting module configured to detect that the first topic is selected in response to a trigger on a conversation continuation entry for the first topic.

In some embodiments, the topic list presentation module 620 is further configured to present the topic list together with the first conversation window in different regions of a client interface.

In some embodiments, the topic viewing entry is presented in a functional region of the conversation window.

It would be understood that one or more of the above methods may be performed by a suitable electronic device or a combination of electronic devices. Such electronic device or a combination of the electronic devices may include, for example, the server 130, the terminal device 110, and/or a combination of the server 130 and the terminal device 110 in FIG. 1.

FIG. 7 illustrates a block diagram of an electronic device 700 in which one or more embodiments of the present disclosure may be implemented. It would be understood that the electronic device 700 shown in FIG. 7 is merely exemplary and should not constitute any limitation on the functionality and scope of the embodiments described herein. The electronic device 700 shown in FIG. 7 may be used to implement the terminal device 110 of FIG. 1, device 500 and/or device 6 as shown in FIG. 5 and FIG. 6.

As shown in FIG. 7, the electronic device 700 is in the form of a general-purpose electronic device. Components of the electronic device 700 may include, but are not limited to, one or more processors or processing units 710, a memory 720, a storage device 730, one or more communications units 740, one or more input devices 750, and one or more output devices 760. The processing unit 710 may be an actual or virtual processor and can perform various processes according to programs stored in the memory 720. In a multiprocessor system, a plurality of processing units execute computer executable instructions in parallel, so as to improve the parallel processing capability of the electronic device 700.

The electronic device 700 typically includes many computer storage media. Such media may be any available media that are accessible by the electronic device 700, including, but not limited to, volatile and non-volatile media, removable and non-removable media. The memory 720 may be a volatile memory (e. g., a register, cache, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium such as a flash drive, a magnetic disk, or any other medium that can be used to store information and/or data and that can be accessed within the electronic device 700.

The electronic device 700 may further include additional removable/non-removable, volatile/nonvolatile storage media. Although not shown in FIG. 7, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 implements communication with other electronic devices through a communication medium. In addition, functions of components of the electronic device 700 may be implemented by a single computing cluster or a plurality of computing machines, and these computing machines can communicate through a communication connection. Thus, the electronic device 700 may operate in a networked environment using logical connections to one or more other servers, network personal computers (PCs), or another network node.

The input device 750 may be one or more input devices such as a mouse, keyboard, trackball, etc. The output device 760 may be one or more output devices such as a display, speaker, printer, etc. The electronic device 700 may also communicate with one or more external devices (not shown) such as a storage device, a display device, or the like through the communication unit 740 as required, and communicate with one or more devices that enable a user to interact with the electronic device 700, or communicate with any device (e. g., a network card, a modem, or the like) that enables the electronic device 700 to communicate with one or more other electronic devices. Such communication may be performed via an input/output (I/O) interface (not shown).

According to an exemplary implementation of the present disclosure, a computer readable storage medium is provided, on which a computer-executable instruction is stored, wherein the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

I/We claim:

1. A method for conversation interaction, comprising:
presenting, in a conversation window of a first conversation, a conversation continuation entry for at least one topic in the first conversation, a conversation continuation entry for a first topic of the at least one topic being presented independently of a conversation message of the corresponding topic; and
in response to detecting a trigger on the conversation continuation entry for the first topic, presenting a first topic region corresponding to the first topic, the first topic region comprising a conversation message related to the first topic in the first conversation.

2. The method of claim 1, wherein the first topic region comprises an input region based on which a subsequent message input by a user for the first topic is received.

3. The method of claim 1, wherein the conversation window comprises one of the following:
a conversation window between the first user and a digital assistant,
a private chat window between the first user and a second user, or
a group chat window between the first user and a group of users.

4. The method of claim 1, wherein presenting the conversation continuation entry for the at least one topic in the first conversation comprises:
presenting a new topic guidance message in the conversation window of the first conversation, the new topic guidance message comprising a conversation continuation entry for at least one recommended historical topic in the first conversation.

5. The method of claim 4, wherein the new topic guidance message is presented in the conversation window of the first conversation in response to a new topic starting operation.

6. The method of claim 4, wherein the at least one recommended historical topic comprises a predetermined number of recent historical topics in the first conversation.

7. The method of claim 1, wherein the conversation continuation entry for the first topic of the at least one topic is presented at an associated location of a topic division line for the corresponding topic in the conversation window, and wherein conversation messages in two adjacent topics in the conversation window are separated with the topic division line.

8. The method of claim 1, wherein presenting the conversation continuation entry for the at least one topic in the first conversation comprises:
presenting a topic viewing entry in the conversation window of the first conversation; and
in response to detecting a trigger on the topic viewing entry, presenting a topic list in the first conversation, at least part of topics in the topic list having a conversation continuation entry.

9. The method of claim 1, wherein a conversation message received in the first topic region is recorded in a region corresponding to the first topic in the conversation window of the first conversation.

10. The method of claim 1, wherein
the first topic region is presented together with the conversation window in different regions of a client interface, or
a location of the first topic region is independent of the conversation window, or
the first topic region is presented in a predetermined region of the conversation window.

11. A method for conversation interaction, comprising:
presenting a topic viewing entry in a conversation window of a first conversation;
in response to detecting a trigger on the topic viewing entry, presenting a topic list in the first conversation; and
in response to detecting that a first topic in the topic list is selected, presenting content of the first topic.

12. The method of claim 11, wherein presenting the content of the first topic comprises:
presenting a first topic region corresponding to the first topic, the first topic region comprising content of the first topic.

13. The method of claim 12, wherein the first topic region comprises an input region based on which a subsequent message input by a user for the first topic is received.

14. The method of claim 12, wherein
the first topic region is presented together with the conversation window in different regions of a client interface, or
a location of the first topic region is independent of the conversation window, or
the first topic region is presented in a predetermined region of the conversation window.

15. The method of claim 12, wherein a conversation message received in the first topic region is recorded in a region corresponding to the first topic in the conversation window of the first conversation.

16. The method of claim 11, wherein each topic in the topic list has a conversation continuation entry, and the method further comprises:
in response to a trigger on a conversation continuation entry for the first topic, detecting that the first topic is selected.

17. The method of claim 11, wherein presenting the topic list comprises:
presenting the topic list together with the first conversation window in different regions of a client interface.

18. The method of claim 11, wherein the topic viewing entry is presented in a functional region of the conversation window.

19. An electronic device, comprising:
at least one processing unit; and
at least one memory, the at least one memory being coupled to the at least one processing unit and storing instructions for execution by the at least one processing unit, the instructions, when executed by the at least one processing unit, causing the device to perform acts comprising:
presenting, in a conversation window of a first conversation, a conversation continuation entry for at least one topic in the first conversation, a conversation continuation entry for a first topic of the at least one topic being presented independently of a conversation message of the corresponding topic; and
in response to detecting a trigger on the conversation continuation entry for the first topic, presenting a first topic region corresponding to the first topic, the first topic region comprising a conversation message related to the first topic in the first conversation.

20. The electronic device of claim 19, wherein presenting the conversation continuation entry for the at least one topic in the first conversation comprises:
presenting a new topic guidance message in the conversation window of the first conversation, the new topic guidance message comprising a conversation continuation entry for at least one recommended historical topic in the first conversation.
